(19) United States
(12) Patent Application Publication
(10) Pub. No.: US 2009/0006813 A1
(43) Pub. Date: Jan. 1, 2009

(54) DATA FORWARDING FROM SYSTEM MEMORY-SIDE PREFETCHER

(76) Inventors: Abhishek Singhal, Beaverton, OR (US); Hemant G. Rotithor, Hillsboro, OR (US)

Correspondence Address: INTEL CORPORATION;c/o INTELLEVATE, LLC, P.O. BOX 52050, MINNEAPOLIS, MN, 55402, US

(21) Appl. No.: 11/770,314

(22) Filed: Jun. 28, 2007

(51) Int. Cl. G06F 9/30

(52) U.S. Cl. 712/207

(57) ABSTRACT

An apparatus, system, and method are disclosed. In one embodiment, the apparatus includes a system memory-side prefetcher that is coupled to a memory controller. The system memory-side prefetcher includes a stride detection unit to identify one or more patterns in a stream. The system memory-side prefetcher also includes a prefetch injection unit to insert prefetches into the memory controller based on the detected one or more patterns. The system memory-side prefetcher also includes a prefetch data forwarding unit to forward the prefetched data to a cache memory coupled to a processor.

### FIELD OF THE INVENTION

The invention relates to prefetching. More specifically, the invention relates to forwarding data to a cache memory by prefetching data with a system memory-side prefetcher.

### BACKGROUND OF THE INVENTION

Performing data prefetching on a stream of processor requests is typically done by processor-side prefetchers. A stream is a sequence of addresses in a memory region. Processor-side prefetchers refer to prefetchers that are closely coupled with the processor core logic and caches. However, processor-side prefetchers typically have limited information on the state of the memory system (e.g. opened and closed pages). The ability to exchange information with the memory controller about the state of system memory across an interconnect is either limited by the semantics of the interconnect in some cases, or is not available at all in other cases. In addition, even when the information is transmitted to the processor-side prefetcher, the information is not the most current, since memory pages open and close at a rapid rate.

Another type of prefetcher is a system memory-side prefetchers, which are closely coupled to the system memory controller. A system memory-side prefetcher utilizes up-to-date state information for the memory system (such as the opened and closed pages) to optimally prefetch data.

Stride detection is a primary mechanism for a prefetcher. A stride detecting prefetcher anticipates the future read requests of a processor by examining the sequence addresses of memory requests generated by the processor to determine if the requested addresses exhibit a recurring pattern. For example, if the processor is stepping through memory using a constant offset between subsequent memory read requests, the stride based prefetcher attempts to recognize this constant stride and prefetch data according to this recognized pattern. This pattern detection may be done in the processor core or close to the memory controller. Performing stride based prefetching near the processor core is helpful because the processor core has greater visibility into all addresses for a given software application and thus can detect patterns more easily and then prefetch based on these patterns.

Prefetch injection involves injecting prefetches, into the memory controller, to future address locations that a stream is expected to generate. Prefetch variables such as the number of prefetches in a given clock and how far from the current memory request location prefetches are done can be controlled with appropriate heuristics. If processor-side injected prefetches miss the last level cache they can also cause system memory page misses, which potentially can increase system memory latencies and lead to memory utilization inefficiencies. For example, a potential advantage of injecting prefetches at the memory controller is that the prefetches may only be injected to open pages so that they don't cause page misses, thus, allowing system memory to maintain high efficiency.

Prefetch data storage, which focuses on the location where prefetches are stored, is another key attribute in prefetch definition. Processor-side prefetchers may bring data into one or more processor core caches and access it from there. The advantage of doing this is that the prefetches can be stored in a large buffer; have smaller latency of access by the processor and the same buffer can be shared between processor memory read requests and prefetches. The disadvantage of using processor caches for storing processor-side prefetched data is that the prefetches may replace data that is in the process of being operated on or replace data that might have use in the near future. System memory-side prefetchers use a prefetch buffer in the memory controller to avoid the replacement of code that is being actively worked on and also to save interconnect bandwidth due to prefetches, but the prefetch buffer may be limited in size due to power consumption or gate area restrictions in the memory controller.

### BRIEF DESCRIPTION OF THE DRAWINGS

The present invention is illustrated by way of example and is not limited by the figures of the accompanying drawings, in which like references indicate similar elements, and in which:

FIG. 1 describes an embodiment of system memory-side prefetcher.

FIG. 2 is a flow diagram of one embodiment of a process to forward prefetched data from a stream to a last level cache memory.

FIG. 3 is a flow diagram of another embodiment of a process to forward prefetched data to the last level cache memory.

### DETAILED DESCRIPTION OF THE INVENTION

Embodiments of an apparatus, system, and method to forward data from a system memory-side prefetcher are described. In the following description, numerous specific details are set forth. However, it is understood that embodiments may be practiced without these specific details. In other instances, well-known elements, specifications, and protocols have not been discussed in detail in order to avoid obscuring the present invention.

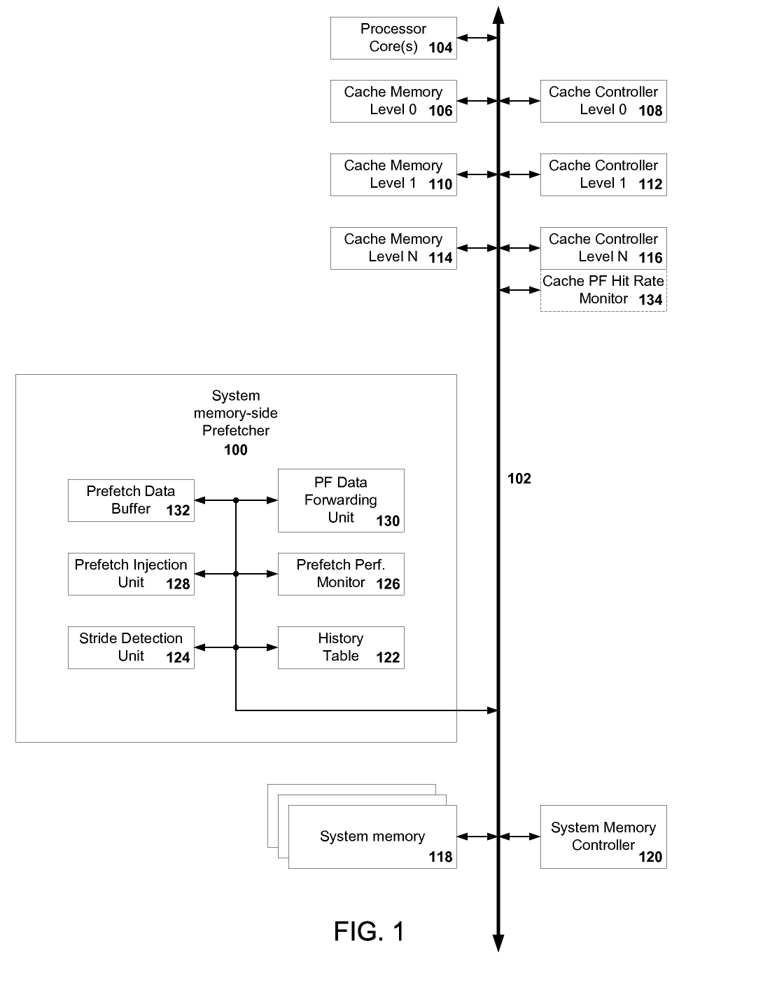

FIG. 1 describes an embodiment of a system and apparatus that includes a system memory-side prefetcher with data forwarding. In many embodiments, the system memory-side prefetcher 100 is coupled to an interconnect 102. One or more processor cores 104 are also coupled to the interconnect 102. In other multiprocessor embodiments, there are multiple processor dies coupled together, each including one or more cores per die (the architecture for processor cores on multiple dies is not shown in FIG. 1). In different embodiments, the processor core(s) 104 may be any type of central processing unit (CPU) designed for use in any form of personal computer, handheld device, server, workstation, or other computing device available today. The single interconnect 102 is shown for ease of explanation so as to not obscure the invention. In practice, this single interconnect may be comprised of multiple interconnects coupling different individual devices together. Additionally, in many embodiments, more devices may be coupled to the interconnect that are not shown (e.g. a chipset).

The prefetcher 100 is termed “system memory”—side prefetcher because in many embodiments, the prefetcher is located in closer proximity to the system memory 118 than to the processor core(s) 104. In some embodiments, the system memory-side prefetcher is coupled directly to the system memory controller 120.

In many embodiments, one or more cache memories are coupled to the interconnect 102 through one or more cache controllers. In some embodiments, the cache memory in closest proximity to the processor core(s) 104 is cache memory level 0 (106). In some embodiments, cache memory level 0 (106) is a static random access memory (SRAM) cache. In many embodiments, cache memory level 0 (106) is coupled to the cache through cache controller level 0 (108). Cache controller level 0 (108) manages access to cache memory level 0 (106). Additionally, other cache memories are also coupled to the interconnect 102 through their respective cache controllers. For example, in many embodiments, cache memory level 1 (110) is coupled to the interconnect 102, through cache controller level 1 (112), at a further distance from the processor core(s) than is cache memory level 0 (108), which creates additional latency for the processor when it attempts to access information from within the level 1 cache than from within the level 0 cache. In some embodiments, one or more of the cache memories are located on the same Silicon die as the processor core(s) 104.

This hierarchical cache memory structure continues until cache memory level N 114, which is coupled to the interconnect 102 through cache controller level N 116, where N is the largest positive number for any cache in the system. This designation makes cache memory level N 114 the last level cache (LLC). For the remainder of the document, the LLC and any other higher level cache memory such as cache memory level 0 or cache memory level 1 will be collectively referred to as “cache memory” unless specifically referred to as otherwise.

System memory 118 is additionally coupled to the interconnect 102 through a system memory controller 120, in many embodiments. All accesses to system memory are sent to the system memory controller 120. In different embodiments, the system memory may be double data rate (DDR) memory, DDR2 memory, DDR3 memory, or any other type of viable DRAM. In some embodiments, the system memory controller 120 is located on the same silicon die as the memory controller hub portion of a chipset.

In many embodiments, the system memory-side prefetcher 100 may include a history table 122, a stride detector unit 124, a prefetch performance monitor 126, a prefetch injection unit 128, a prefetch data forwarding unit 130, and a prefetch data buffer 132. These components of the system memory-side prefetcher 100 are discussed in the following paragraphs. The term “data” is utilized for ease of explanation regarding the information prefetched. In relationship to prefetching data and forwarding it to a cache, in most embodiments, the size of the data prefetched and forwarded is a cache line worth of data (e.g. 64 Bytes of data).

The history table 122 stores information related to one or more streams. For example, each stream has a current page in memory that its memory requests are accessing. The history table 122 stores the address of the current memory page the stream is accessing as well as an offset into the page where address of the current memory request in the stream is specifically pointing to. Furthermore, the history table 122 can also include information regarding the direction of the stream, such as whether the accesses are going up or down in linear address space among other stream information items.

Additionally, the history table 122 can also store information related to the stride in the stream (if a stride has been detected). Finally, each stream has a prefetch hit ratio stored in the history table 122. The prefetch hit ratio is the ratio of all prefetches hit and all prefetches injected into the system memory controller 120. A prefetch is hit when a memory request from the stream is to an address that has been prefetched. A prefetch is injected into the system memory controller 120 when the prefetched address has been sent to the system memory controller 120 to have the system memory controller 120 return the data at the address.

The stride detector unit 124 examines the addresses of data requested by one or more processor core(s) in the system to determine if the requested addresses exhibit a recurring access pattern. If the processor core(s) step through memory using an offset from address to address that is predictable, the stride detector unit will attempt to recognize this access pattern (or stride). If the stride detector unit does recognize a recurring access pattern in the stream, it will report the stride information to the history table 122. The stride detector unit may also track data such as whether the access pattern in the stream is moving forward or backward in address space, where the last processor-access occurred in the stream and where, in the stream, was the last prefetch inserted into the system memory controller 120. All or a portion of this information is fed to the history table 122.

The prefetch performance monitor 126 reports the prefetch hit ratio to the history table 122. In some embodiments, logic within the system memory controller 120 will report the total number of prefetch hits to the prefetch performance monitor. Also, in some embodiments, a prefetch injection unit (discussed below), that injects the prefetches into the system memory controller 120, will report the total number of prefetches injected into the system memory controller 120 to the prefetch performance monitor. Thus, the prefetch performance monitor calculates the prefetch hit ratio when the prefetch hits and prefetches injected information is updated and then stores the calculated prefetch hit ratio in the history table 122 per stream.

The prefetch injection unit 128 utilizes information related to the stream that is stored in the history table 122 to determine how much data will be prefetched and how far out in advance of the current location of the stream will data be prefetched. For example, depending on the prefetch hit ratio of a stream, logic within the prefetch injection unit 128 can scale the number of prefetches that are injected into the system memory controller 120. A higher hit ratio may increase the number of prefetches, and a lower hit ratio may decrease the number of prefetches.

Thus, discussion related to the system memory-side prefetcher, to this point, deals with unit interoperability related to prefetching and injecting the prefetches into the system memory controller 120. Once the system memory controller 120 has serviced each of the injected prefetches, the prefetched data returns from system memory 118 along the interconnect 102.

In some embodiments, the prefetch data forwarding unit 130 includes logic that reads the prefetch hit ratio, stored in the history table 122, for the stream that includes the prefetched data and determines, based on the prefetch hit ratio, whether the prefetched data should be forwarded directly to a cache memory, or if the prefetched data should be stored in the prefetch data buffer 132. In other embodiments, the logic that makes this determination is located in the prefetch injection unit 128 and a flag or some other type of information that accompanies the prefetched data tells the prefetch data forwarding unit 130 the location to send the prefetched data.

For example, in some embodiments, there is a threshold value of the prefetch hit ratio, when the prefetch hit ratio is equal to or above the threshold value, the prefetch data forwarding unit sends the prefetched data directly to the cache memory. Otherwise, if the prefetch hit ratio is below the threshold value, the prefetched data is sent to the prefetch data buffer for storage.

The prefetch hit ratio of the stream may change dynamically since the prefetch performance monitor is updating the prefetch hit ratio of the stream in the history table 122 continuously (or, for example, every certain number of memory controller clock cycles). If the prefetch hit ratio starts out below the threshold value and then moves above it, the prefetched data stored in the prefetch data buffer may be sent to the cache memory.

In some embodiments, there are multiple threshold values, where each threshold value is specific to a certain level cache. Thus, the prefetch data forwarding unit may forward prefetched data to the LLC if the prefetch hit ratio is above a LLC threshold value. In the same regard, the prefetch data forwarding unit may forward prefetched data to a next highest level cache if the prefetch hit ratio is above a threshold value for the next highest level cache, and so on.

The definition of a “high” hit ratio would be determined prior to operation. In many embodiments, a hit ratio threshold value is predetermined. For example, in one embodiment, if the hit ratio threshold value is 75%, any stream whose memory accesses hit the prefetched data at a rate of greater than 75% would be designated as a stream whose prefetched data is forwarded to cache memory. In other embodiments, the hit ratio threshold value may be greater than or less than 75% to determine what prefetched data is forwarded to the cache memory.

In some embodiments, a metric other than the prefetch hit ratio is utilized to determine whether the prefetched data is forwarded the cache or stored in the prefetch data buffer. For example, the metric used to determine the threshold ratio may be a mix of information such as the prefetch hit ratio and the distance between the current prefetch address location and current memory request address location. Or in another example, the metric used to determine the threshold ratio may also include the amount of interconnect bandwidth currently being transmitted (where interconnect bandwidth is a function of total amount of data transmitted over a set time period).

In many embodiments, the prefetched data forwarded to the cache memory includes semantic information that indicates the transaction is a system memory-side prefetch. The information attached to the forwarded data would allow the cache controller for the cache memory (e.g. cache controller 116 for the LLC 114) to distinguish between normal demand fetches (those which are brought in for normal cache memory misses) as opposed to system memory-side prefetch data. Storing this information along with the tags in the cache memory will help determine the efficiency of the prefetches in the cache memory (the efficiency determination of the prefetches in the cache memory is discussed below). In some embodiments, a multi-way cache memory may be implemented so that certain ways within the cache memory are dedicated to receiving the forwarded data. Also, in many embodiments, once data, brought in as a prefetch, has been hit in the cache memory, the data's status should be changed from prefetch to non-prefetch.

When prefetch data is forwarded from the system memory-side prefetcher 100 to the cache memory, there may be a reduction in the number of processor requests reaching the system memory controller 120 because some processor memory requests are requesting data from address locations that are now in the cache memory, due to prefetching, as opposed to still residing in system memory 118. Similarly, this would also create a reduction in the number of processor requests reaching the system memory-side prefetcher 100. If the processor requests reaching the prefetcher decrease in frequency, the accuracy of the heuristic(s) in the stride detection unit 124 in recognizing patterns in the addresses will degrade. To alleviate this issue, in many embodiments, the cache controller of the cache memory forwards one or more addresses of prefetch hits in the cache memory to the system memory-side prefetcher 100. In some embodiments, the forwarded address information is received separately for each prefetch hit in the cache memory per processor request. In other embodiments, the cache controller of the cache memory will consolidate the updates and do them after a certain elapsed time period. In many embodiments, the prefetch performance monitor 126 utilizes the forwarded address information to update the history table 122.

As mentioned above, any given piece of prefetch data is either stored in the cache memory (the cache memory stores the forwarded prefetch data) or stored in the prefetch data buffer (the prefetch data buffer stores the non-forwarded prefetch data). A prefetch hit may be to a prefetch stored in the prefetch data buffer or to a prefetch stored in the LLC or another cache. In this scenario, only the prefetch hits to data stored in the data buffer would be reported. Thus, the prefetch performance monitor may additionally need the prefetch data hit/miss information on prefetches stored in all cache memories (the LLC 114 and any higher level caches with prefetches such as cache memory level 0 106 or cache memory level 1 110) to maintain prefetch hit ratio on the entire set of prefetch data. In many embodiments, the cache controller 116 of the LLC 114 includes a cache prefetch hit rate monitor 134 to monitor the hit ratio of prefetched data within the LLC 114. The cache prefetch hit rate monitor 134 will forward the hit/miss information back to the prefetch performance monitor 126 within the system memory-side prefetcher 100. In some embodiments, the cache prefetch hit rate monitor 134 may send the hit/miss information to the prefetch performance monitor 126 periodically (such as in a similar manner to how the cache controller 116 sends the forwarded address information to the prefetch performance monitor 126). In some embodiments, a cache prefetch hit rate monitor is coupled to more than one cache memory. In some embodiments, there is a cache prefetch hit rate monitor coupled to each cache memory shown in FIG. 1 (106, 110, and 114) to report the hits and misses to prefetched data stored in each of their respective caches, though these embodiments are not shown.

All of the cache controllers of all the cache memories (106, 110, 114, etc) may have a set of eviction policies related to the priority of data already in their respective cache memories versus the prefetched data that the system memory-side prefetcher is attempting to populate in one or more of the cache memories. In many embodiments, a given cache controller may have a different cache eviction policy (with potentially different eviction priority levels) for prefetch requests stored in its cache memory versus non-prefetch requests stored in its cache memory. In some embodiments, if a cache memory already has prefetched data, the policy may be to overwrite this data. In other embodiments, the prefetched forwarded data may be dropped. Other embodiments may be created based on preset system preferences.

In some embodiments, a cache controller (such as cache controller 116) can prevent possible cache pollution due to aggressive prefetches by giving priority to older prefetches over non-prefetch ways when deciding what to evict from its cache memory. Additionally, in some embodiments, a cache controller can drop prefetches if it finds that prefetch allocation may cause evictions of cache lines in a modified state currently residing in the cache memory.

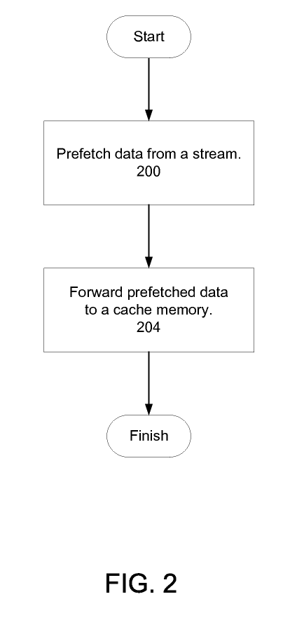

FIG. 2 is a flow diagram of one embodiment of a process to forward prefetched data from a stream to a last level cache memory. The process is performed by processing logic that may comprise hardware (circuitry, dedicated logic, etc.), software (such as is run on a general purpose computer system or a dedicated machine), or a combination of both. In many embodiments, processing logic is located within the system memory-side prefetcher. Referring to FIG. 2, the process begins by processing logic prefetching data from a stream (processing block 200). In different embodiments, there may be one or more streams of system memory read accesses. In some embodiments, the system memory has interleaved channels and multiple streams are being transmitted simultaneously.

In many embodiments, the prefetcher is located in close proximity to the system memory controller. In some embodiments, the prefetcher is located on the same Silicon die as the system memory controller. For example, if a processor core sends memory requests across an interconnect to a memory controller that is coupled to system memory, in some embodiments, “close proximity” to the system memory controller means coupled directly to the system memory controller on the system memory controller end of the interconnect. In other embodiments, the prefetcher is in “closer proximity” to the system memory controller than they are to the processor core sending the memory request. In these embodiments, the prefetcher is just closer to the system memory controller than to the processor core, and thus, there is a smaller latency when communicating with the system memory controller than the latency of the communications with the processor core.

Finally, processing logic forwards the prefetched data to cache memory (processing block 202) and the process is finished. In some embodiments, the prefetched data is forwarded to a cache memory, such as the LLC 114 in FIG. 1. In other embodiments, the prefetched data is forwarded to another cache (such as cache memory level 0 106 or cache memory level 1 110 in FIG. 1).

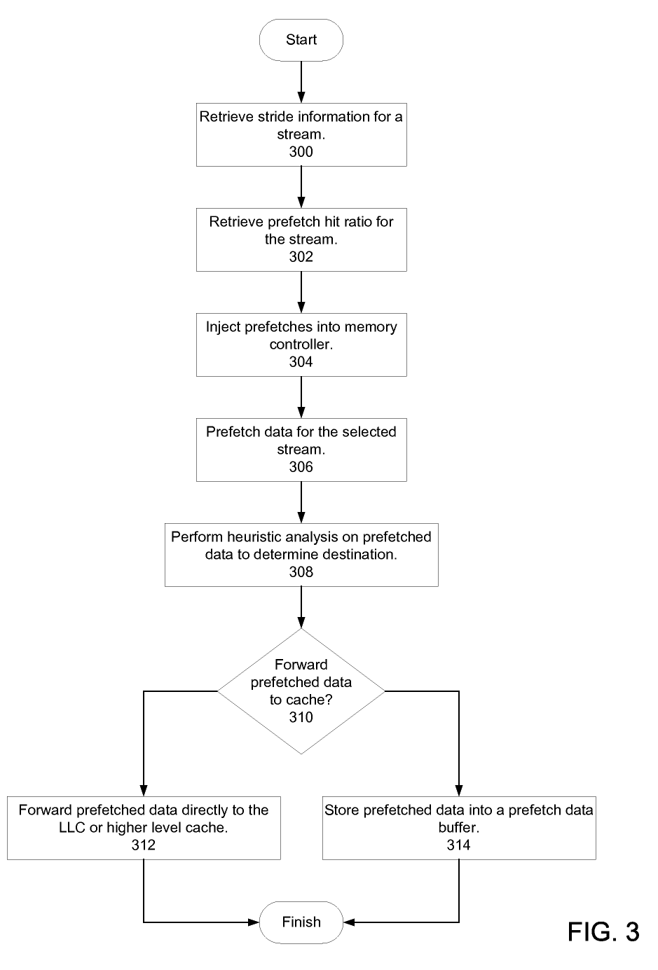

FIG. 3 is a flow diagram of another embodiment of a process to forward prefetched data from a stream to a cache memory. The process is performed by processing logic that may comprise hardware (circuitry, dedicated logic, etc.), software (such as is run on a general purpose computer system or a dedicated machine), or a combination of both. In many embodiments, processing logic is located within the system memory-side prefetcher. Referring to FIG. 3, the process begins by processing logic retrieving stride information for a stream (processing block 300). Next, processing logic retrieves the prefetch hit ratio for the stream (processing block 302). In many embodiments, the prefetch hit ratio is calculated using the prefetches stored within a prefetch data buffer as well as the prefetches stored in cache memories (such as a last level cache or a higher level cache closer in proximity to the processor core(s)). In some embodiments, other information other than the prefetch hit ratio, such as the distance between the current prefetch address location and current memory request address location is also retrieved from the stream.

Then, processing logic injects the prefetches into the system memory controller (processing block 304). The injected prefetches are serviced by the system memory controller and the system memory controller returns data across the interconnect retrieved from the prefetched locations. Next, processing logic prefetches data for the selected stream (processing block 306). In many embodiments, the amount of prefetches and the distance the prefetches are prefetched in front of the current location of the stream are based on information retrieved regarding the stream (e.g. the prefetch hit ratio information).

Next, processing logic performs heuristic analysis on the prefetched data sent from the memory controller to determine the destination of the prefetched data (processing block 308). In some embodiments, the prefetch hit ratio is utilized to determine whether the prefetched data is forwarded to the cache or stored in a prefetch data buffer. Processing logic then determines whether the prefetched data is forwarded to the cache or stored in the prefetch data buffer based on the analysis (processing block 310). If processing logic determines to forward the data, then processing logic forwards the prefetched data directly to the cache memory (processing block 312). The specific cache, such as the LLC or a higher level cache, that the data is forwarded to may also be determined by the heuristic analysis (this analysis is described above in reference to FIG. 1). Otherwise, if processing logic determines not to forward the data, then processing logic stores the prefetched data in the prefetch data buffer (processing block 314). In some embodiments, the data stored in the prefetch data buffer may be forwarded to cache memory at a later time if the information that processing logic performed the heuristic analysis on changes.

Thus, embodiments of an apparatus, system, and method to forward data from a system memory-side prefetcher are described. These embodiments have been described with reference to specific exemplary embodiments thereof. It will be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

What is claimed is:

1. An apparatus, comprising:
a system memory-side prefetcher, coupled to a memory controller, comprising
a stride detection unit to identify one or more patterns in a stream;
a prefetch injection unit to insert prefetches into the memory controller based on the detected one or more patterns;
a prefetch data forwarding unit to forward the prefetched data to a cache memory coupled to a processor.

2. The apparatus of claim 1, wherein the system memory-side prefetcher further comprises a prefetch performance monitor to
monitor one or more heuristics of the stream;
report the one or more heuristics of the stream to a history table of stream information.

3. The apparatus of claim 2, wherein one of the one or more heuristics further comprises a prefetch hit ratio, the prefetch hit ratio comprising the number of prefetch hits in the stream versus the number of prefetches inserted into the memory controller.

4. The apparatus of claim 3, wherein the prefetch data forwarding unit is further operable to
read the prefetch hit ratio of the stream from the history table;
forward the prefetched data to the cache memory when the prefetch hit ratio of the stream is greater than or equal to a predetermined prefetch hit ratio threshold value; and
store the prefetched data to a prefetch data buffer when the prefetch hit ratio of the stream is less than the predetermined prefetch hit ratio threshold value.

5. The apparatus of claim 4, wherein the prefetch performance monitor is further operable to
receive a forwarded address from a cache controller coupled to the cache memory, the forwarded address comprising a prefetch hit address location in the cache memory; and
update the prefetch hit ratio for the stream in the history table with a new ratio that includes the prefetch hit from the address location in the cache memory.

6. The apparatus of claim 4, wherein the prefetch performance monitor is further operable to:
receive prefetch hit and miss information from the cache controller;
calculate the prefetch hit ratio using the received prefetch hit and miss information;
send the prefetch hit ratio to the history table.

7. The apparatus of claim 1, wherein the prefetch data forwarding unit is further operable to forward prefetched data to a non-last level cache memory.

8. A system, comprising:
an interconnect;
a processor, coupled to the interconnect;
a first cache memory coupled to the interconnect;
a second cache memory coupled to the interconnect;
a system memory-side prefetcher, coupled to the interconnect, comprising
a stride detection unit to identify one or more patterns in a stream;
a prefetch injection unit to insert prefetches into a system memory controller, coupled to a system memory, based on the detected one or more patterns;
a prefetch data forwarding unit to forward the prefetched data to the first cache memory; and
a prefetch performance monitor to monitor one or more heuristics of the stream;
a cache controller, coupled to the first cache memory, the cache controller to
detect a prefetch hit to the first cache memory targeting an address in the first cache memory that is storing prefetched data forwarded by the prefetch data forwarding unit; and
forward the address to the prefetch performance monitor.

9. The system of claim 8, wherein the prefetch performance monitor is further operable to:
report the one or more heuristics of the stream to a history table of stream information.

10. The system of claim 9, wherein one of the one or more heuristics further comprises a prefetch hit ratio, the prefetch hit ratio comprising the number of prefetch hits in the stream versus the number of prefetches inserted into the system memory controller.

11. The system of claim 10, wherein the prefetch data forwarding unit is further operable to
read the prefetch hit ratio of the stream from the history table;
forward the prefetched data to the first cache memory when the prefetch hit ratio of the stream is greater than or equal to a predetermined first cache memory prefetch hit ratio threshold value;
forward the prefetched data to the second cache memory when the prefetch hit ratio of the stream is greater than or equal to a predetermined second cache memory prefetch hit ratio threshold value; and
store the prefetched data to a prefetch data buffer when the prefetch hit ratio of the stream is less than the predetermined first and second cache memory prefetch hit ratio threshold values.

12. The system of claim 11, wherein the prefetch performance monitor is further operable to
update the prefetch hit ratio for the stream in the history table with a new ratio that includes the prefetch hit from the address location in the first cache memory.

13. The system of claim 8, wherein the prefetch data forwarding unit is further operable to forward prefetched data to a second, non-last level cache memory.

14. An method, comprising:
identifying one or more patterns in a stream;
inserting prefetches into a system memory controller based on the detected one or more patterns;
forwarding the prefetched data to a cache memory coupled to a processor.

15. The method of claim 14, further comprising:
monitoring one or more heuristics of the stream;
reporting the one or more heuristics of the stream to a history table of stream information.

16. The method of claim 15, wherein one of the one or more heuristics further comprises a prefetch hit ratio, the prefetch hit ratio comprising the number of prefetch hits in the stream versus the number of prefetches inserted into the system memory controller.

17. The method of claim 3, further comprising:
reading the prefetch hit ratio of the stream from the history table;
forwarding the prefetched data to the cache memory when the prefetch hit ratio of the stream is greater than or equal to a predetermined prefetch hit ratio threshold value; and
storing the prefetched data to a prefetch data buffer when the prefetch hit ratio of the stream is less than the predetermined prefetch hit ratio threshold value.

18. The method of claim 17, further comprising:
receiving a forwarded address from a cache controller coupled to the cache memory, the forwarded address comprising a prefetch hit address location in the cache memory; and
updating the prefetch hit ratio for the stream in the history table with a new ratio that includes the prefetch hit from the address location in the cache memory.

19. The method of claim 18, further comprising:
receiving prefetch hit and miss information from the cache controller;
calculating the prefetch hit ratio using the received prefetch hit and miss information;
sending the prefetch hit ratio to the history table.

20. The method of claim 14, further comprising:
forwarding prefetched data to a non-last level cache memory.
